(19) United States
(12) Patent Application Publication
(10) Pub. No.: US 2022/0046583 A1
(43) Pub. Date: Feb. 10, 2022

(54) METHOD AND DEVICE FOR PAGING

(71) Applicant: Samsung Electronics Co., Ltd., Suwon-si (KR)

(72) Inventors: Hong WANG, Beijing (CN); Lixiang XU, Beijing (CN); Weiwei WANG, Beijing (CN)

(21) Appl. No.: 17/444,433

(22) Filed: Aug. 4, 2021

(30) Foreign Application Priority Data
Aug. 6, 2020 (CN) 202010785163.0

(51) Int. Cl. H04W 68/00; H04W 24/10; H04W 76/28

(52) U.S. Cl. CPC H04W 68/005; H04W 76/28; H04W 24/10

(57) ABSTRACT

The present disclosure provides a method and device for paging. A method for paging performed by a base station of a first communication system, may comprise: receiving, from a UE, a message including information about paging configuration of a second communication system; and sending, to the UE, a message for configuring a measurement interval for the second communication system of the UE, according to the information about the paging configuration of the second communication system.

### CROSS REFERENCE TO RELATED APPLICATION

This application is based on and claims priority under 35 U.S.C. § 119 to Chinese Patent Application No. 202010785163.0, filed on Aug. 6, 2020, in the Chinese Intellectual Property Office, the disclosure of which is incorporated by reference herein in its entirety.

### BACKGROUND

### 1. Field

The present application relates to wireless communication technology, and in particular to an improved method and device for initiating a service request by a network and paging a UE by the network.

### 2. Description of Related Art

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

### SUMMARY

In the prior art, there is a demand for an improved method and device for initiating a service request by a network and paging a UE by a network.

According to an aspect of the present disclosure, there is provided a method for paging performed by a base station of a first communication system, comprising: receiving, from a UE, a message including information about paging configuration of a second communication system; and sending, to the UE, a message for configuring measurement for the second communication system of the UE, according to the information about the paging configuration of the second communication system.

According to an embodiment of the present disclosure, the method further comprises: sending a message for requesting the paging configuration of the second communication system to the UE.

According to an embodiment of the present disclosure, the method further comprises: sending a message for reporting information about paging of the second communication system to a core network node of the first communication system.

According to an embodiment of the present disclosure, the information about the paging configuration of the second communication system includes at least one of the following: a system identity of the second communication system, a paging identity of the UE in the second communication system, a paging discontinuous reception parameter of the UE in the second communication system, a default paging cycle in the second communication system, or a paging frame offset in the second communication system.

According to an aspect of the present disclosure, there is provided a method for paging performed by a core network node of a first communication system, comprising: receiving, from a base station of the first communication system, a message for reporting paging information about the first communication system; and sending, to a core network node of a second communication system, a message including information about paging configuration of the first communication system.

According to an embodiment of the present disclosure, the paging information about the first communication system includes at least one of the following: a default paging cycle in the first communication system, or a paging frame offset in the first communication system.

According to an embodiment of the present disclosure, the information about the paging configuration of the first communication system includes at least one of the following: a paging identity of a UE in the first communication system, a paging discontinuous reception parameter of the UE in the first communication system, a default paging cycle in the first communication system, or a paging frame offset in the first communication system.

According to an aspect of the present disclosure, there is provided a method for paging performed by a base station of a second communication system, comprising: receiving, from a core network node of the second communication system, a message for establishing UE context; and sending, to the UE, a message for configuring measurement for a first communication system of the UE, wherein, the message for establishing the UE context includes information about paging configuration of the first communication system.

According to an embodiment of the present disclosure, the information about the paging configuration of the first communication system includes at least one of the following: a paging identity of the UE in the first communication system, a paging discontinuous reception parameter of the UE in the first communication system, a default paging cycle in the first communication system, or a paging frame offset in the first communication system.

According to an embodiment of the present disclosure, the method further comprises: receiving a message requesting to establish an RRC connection from the UE, wherein, the message requesting to establish the RRC connection includes an identity of the UE in the first communication system and/or information for finding a core network node of the first communication system.

According to an embodiment of the present disclosure, the method further comprises: sending a message including initial information about the UE to a core network node of the second communication system, wherein, the message about the initial information of the UE includes the identity of the UE in the first communication system and/or information for finding a core network node of the first communication system.

According to an aspect of the present disclosure, there is provided a method for paging performed by a core network node of a first communication system, comprising: receiving, from a base station of the first communication system, a message indicating a paging failure, the message including information about paging of the first communication system; and sending, to a core network node of a second communication system, the information about the paging of the first communication system.

According to an embodiment of the present disclosure, the information about the paging of the first communication system includes at least one of the following: a temporary identity assigned to a UE by the first communication system, a paging discontinuous reception parameter of the UE in the first communication system, a default paging cycle in the first communication system, or a paging frame offset in the first communication system.

According to an aspect of the present disclosure, there is provided a method for paging performed by a core network node of a second communication system, comprising: receiving, from a core network node of a first communication system, information about paging of the first communication system; and sending, to a base station of the second communication system, a paging message, the paging message including information indicating the first communication system that initiates the paging.

According to an embodiment of the present disclosure, the information about the paging of the first communication system includes at least one of the following information: a temporary identity assigned to a UE by the first communication system, a paging discontinuous reception parameter of the UE in the first communication system, a default paging cycle in the first communication system, or a paging frame offset in the first communication system.

According to an aspect of the present disclosure, there is provided a base station of a first communication system, comprising: a transceiver; a memory configured to store instructions; and a controller configured to enable the base station of the first communication system to perform the methods described in various embodiments when the instructions are executed.

According to an aspect of the present disclosure, there is provided a core network node of a first communication system, comprising: a transceiver; a memory configured to store instructions; and a controller configured to enable the core network node of the first communication system to perform the methods described in the various embodiments when the instructions are executed.

According to an aspect of the present disclosure, there is provided a base station of a second communication system, comprising: a transceiver; a memory configured to store instructions; and a controller configured to enable the base station of the second communication system to perform the methods described in various embodiments when the instructions are executed.

According to an aspect of the present disclosure, there is provided a core network node of a second communication system, comprising: a transceiver; a memory configured to store instructions; and a controller configured to enable the core network node of the second communication system to perform the methods described in the various embodiments when the instructions are executed.

The disclosure provides an improved method and device for initiating a service request by a network and paging a UE by a network. Paging failures can be avoided, a success rate of initiating service requests by the network can be increased, UE power consumption can be avoided, and a delay of paging messages can be reduced.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates a system architecture diagram of System Architecture Evolution (SAE);

FIG. 2 illustrates a schematic diagram of the initial overall architecture of 5G;

FIG. 3 illustrates a schematic diagram according to an embodiment of the present disclosure;

FIG. 4 illustrates a schematic diagram according to an embodiment of the present disclosure;

FIG. 5 illustrates a schematic diagram according to an embodiment of the present disclosure;

FIG. 6 illustrates a schematic diagram according to an embodiment of the present disclosure;

FIG. 7 illustrates a schematic diagram according to an embodiment of the present disclosure;

FIG. 8 illustrates a schematic diagram according to an embodiment of the present disclosure; and

FIG. 9 illustrates a block diagram according to an embodiment of the present disclosure.

### DETAILED DESCRIPTION

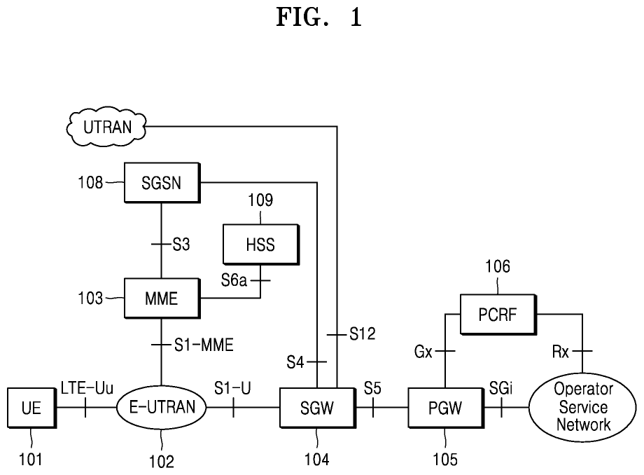

Modern mobile communication increasingly tends to provide users with multimedia services transmitted at a high rate. As shown in FIG. 1, it is a system architecture diagram of system architecture evolution (SAE), in which:

A user equipment (UE) 101 is a terminal device for receiving data. Evolved universal terrestrial radio access network (E-UTRAN) 102 is a radio access network, which includes a macro base station (eNodeB/NodeB) that provides the UE with an interface for accessing to the radio network. A mobility management entity (MME) 103 is responsible for managing the UE's mobility context, session context and security information. A serving gateway (SGW) 104 mainly provides user plane functions, and the MME 103 and the SGW 104 may be at the same physical entity. A packet data network gateway (PGW) 105 is responsible for functions such as charging, lawful interception, etc., and may also be at the same physical entity with SGW 104. A policy and charging rules function entity (PCRF) 106 provides quality of service (QoS) policy and charging criteria. A general packet radio service support node (SGSN) 108 is a network node device that provides routing for data transmission in a universal mobile telecommunication system (UMTS). A home subscriber server (HSS) 109 is a home sub-system of the UE, and is responsible for protecting user information including a current location of the user equipment, an address of a serving node, user security information, the packet data context of the user equipment and so on.

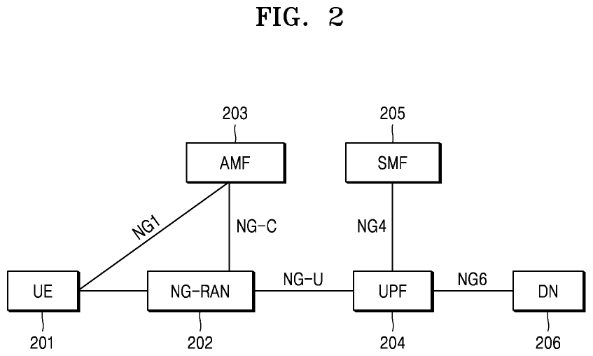

As shown in FIG. 2, it is a system architecture diagram of the next-generation network or the fifth-generation 5G network, in which:

A user equipment (UE) 201 is a terminal device for receiving data. A Next generation radio access network (NG-RAN) 202 is a radio access network, which includes a base station (a gNB or an eNB connected to a 5G core network 5GC, and the eNB connected to the 5GC is also called ng-gNB) that provides the UE with an interface for accessing to the radio network. An access control and mobility management function entity (AMF) 203 is responsible for managing the UE's mobility context and security information. A user plane function entity (UPF) 204 mainly provides user plane functions. A session management function entity (SMF) 205 is responsible for session management. A data network (DN) 206 includes, for example, services of operators, access of Internet and service of third parties.

In the prior art, there is a demand for an improved method and device for initiating a service request by a network and paging a UE by a network.

The paging optimization method provided by the present disclosure can avoid or reduce the extra overhead of multicast data transmission, improve the utilization efficiency of access network resources and/or air interface resources, reduce the transmission delay, reduce the loss of data when the multicast transmission mode is converted, and reduce the delay caused by the conversion of transmission modes.

According to an aspect of the present disclosure, there is provided a method for paging performed by a base station of a first communication system, comprising: receiving, from a UE, a message including information about paging configuration of a second communication system; and sending, to the UE, a message for configuring measurement for the second communication system of the UE, according to the information about the paging configuration of the second communication system.

According to an embodiment of the present disclosure, the method further comprises: sending a message for requesting the paging configuration of the second communication system to the UE.

According to an embodiment of the present disclosure, the method further comprises: sending a message for reporting information about paging of the second communication system to a core network node of the first communication system.

According to an embodiment of the present disclosure, the information about the paging configuration of the second communication system includes at least one of the following: a system identity of the second communication system, a paging identity of the UE in the second communication system, a paging discontinuous reception parameter of the UE in the second communication system, a default paging cycle in the second communication system, or a paging frame offset in the second communication system.

According to an aspect of the present disclosure, there is provided a method for paging performed by a core network node of a first communication system, comprising: receiving, from a base station of the first communication system, a message for reporting paging information about the first communication system; and sending, to a core network node of a second communication system, a message including information about paging configuration of the first communication system.

According to an embodiment of the present disclosure, the paging information about the first communication system includes at least one of the following: a default paging cycle in the first communication system, or a paging frame offset in the first communication system.

According to an embodiment of the present disclosure, the information about the paging configuration of the first communication system includes at least one of the following: a paging identity of a UE in the first communication system, a paging discontinuous reception parameter of the UE in the first communication system, a default paging cycle in the first communication system, or a paging frame offset in the first communication system.

According to an aspect of the present disclosure, there is provided a method for paging performed by a base station of a second communication system, comprising: receiving, from a core network node of the second communication system, a message for establishing UE context; and sending, to the UE, a message for configuring measurement for a first communication system of the UE, wherein, the message for establishing the UE context includes information about paging configuration of the first communication system.

According to an embodiment of the present disclosure, the information about the paging configuration of the first communication system includes at least one of the following: a paging identity of the UE in the first communication system, a paging discontinuous reception parameter of the UE in the first communication system, a default paging cycle in the first communication system, or a paging frame offset in the first communication system.

According to an embodiment of the present disclosure, the method further comprises: receiving a message requesting to establish an RRC connection from the UE, wherein, the message requesting to establish the RRC connection includes an identity of the UE in the first communication system and/or information for finding a core network node of the first communication system.

According to an embodiment of the present disclosure, the method further comprises: sending a message including initial information about the UE to a core network node of the second communication system, wherein, the message about the initial information of the UE includes the identity of the UE in the first communication system and/or information for finding a core network node of the first communication system.

According to an aspect of the present disclosure, there is provided a method for paging performed by a core network node of a first communication system, comprising: receiving, from a base station of the first communication system, a message indicating a paging failure, the message including information about paging of the first communication system; and sending, to a core network node of a second communication system, the information about the paging of the first communication system.

According to an embodiment of the present disclosure, the information about the paging of the first communication system includes at least one of the following: a temporary identity assigned to a UE by the first communication system, a paging discontinuous reception parameter of the UE in the first communication system, a default paging cycle in the first communication system, or a paging frame offset in the first communication system.

According to an aspect of the present disclosure, there is provided a method for paging performed by a core network node of a second communication system, comprising: receiving, from a core network node of a first communication system, information about paging of the first communication system; and sending, to a base station of the second communication system, a paging message, the paging message including information indicating the first communication system that initiates the paging.

According to an embodiment of the present disclosure, the information about the paging of the first communication system includes at least one of the following information: a temporary identity assigned to a UE by the first communication system, a paging discontinuous reception parameter of the UE in the first communication system, a default paging cycle in the first communication system, or a paging frame offset in the first communication system.

According to an aspect of the present disclosure, there is provided a base station of a first communication system, comprising: a transceiver; a memory configured to store instructions; and a controller configured to enable the base station of the first communication system to perform the methods described in various embodiments when the instructions are executed.

According to an aspect of the present disclosure, there is provided a core network node of a first communication system, comprising: a transceiver; a memory configured to store instructions; and a controller configured to enable the core network node of the first communication system to perform the methods described in the various embodiments when the instructions are executed.

According to an aspect of the present disclosure, there is provided a base station of a second communication system, comprising: a transceiver; a memory configured to store instructions; and a controller configured to enable the base station of the second communication system to perform the methods described in various embodiments when the instructions are executed.

According to an aspect of the present disclosure, there is provided a core network node of a second communication system, comprising: a transceiver; a memory configured to store instructions; and a controller configured to enable the core network node of the second communication system to perform the methods described in the various embodiments when the instructions are executed.

The disclosure provides an improved method and device for initiating a service request by a network and paging a UE by a network. Paging failures can be avoided, a success rate of initiating service requests by the network can be increased, UE power consumption can be avoided, and a delay of paging messages can be reduced.

In the following embodiments, description is made by taking a 5G system as an example, taking a CU-CP as an example of an access network control plane, taking a CU-UP as an example of an access network user plane, and taking a DU as an example of a distribution unit. The method is also used for corresponding entities of other systems.

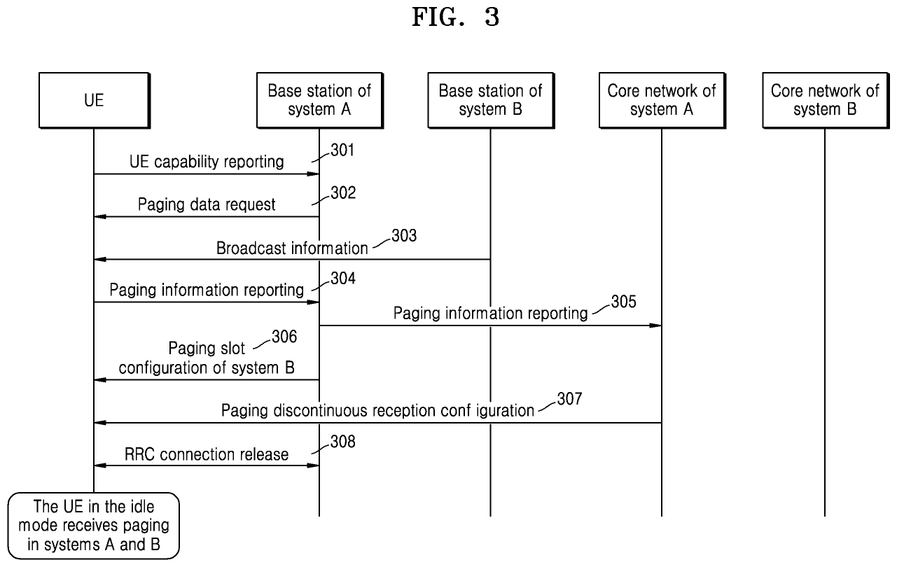

An embodiment of a method for paging optimization of the present disclosure is depicted in FIG. 3. A system A and a system B are two communication systems. A UE can be connected to the system A or the system B, and the UE cannot access to two systems A and B at the same time. FIG. 3 depicts a procedure in which the UE is in the RRC connection state in the system A and in the idle mode in the system B, the system A configures how the UE receives paging information of the system B. Detailed descriptions of steps unrelated to the present disclosure are omitted here. The method includes following steps.

At step 301, the UE sends an RRC message to a base station of the system A.

The UE currently establishes a radio connection (RRC connection) with a cell of the base station of the system A. The UE is in the RRC connection state in the system A. The cell is a serving cell of the UE. The base station and the cell are not distinguished below. The base station sends a message to the UE, which means that the cell of the base station sends the message to the UE. The current procedure can be used to establish the RRC connection. After the RRC connection is established, the UE sends the RRC message; or in the last message, i.e., an RRC setup complete message, in the procedure of establishing the RRC connection, the UE reports the capability information of the UE to the base station of the system A. The UE currently has no RRC connection with the base station B of the system B, the UE camps on a certain cell in the system B, and the UE is in the idle mode. The system A can be a 3G system, a 4G system, a 5G system, or other wireless communication systems. The base station of the system A can be a 3G base station, a 4G base station, a 5G base station, or a base station of other radio access systems in the future. The system B can be a 3G system, a 4G system, a 5G system, or other wireless communication systems. The base station of the system B can be a 3G base station, a 4G base station, a 5G base station, or a base station of other radio access systems in the future.

The capability information of the UE indicates that the UE only has the capability of being connected to the system A or the system B, and does not have the capability of being connected to the system A and the system B at the same time. The capability information of the UE also indicates what kind of access system the system B is, such as 4G LTE, 5G LTE, 5G NR, etc., and can also include a unique identity of the UE in the system B, such as the international mobile subscriber identity (IMSI) of the UE.

The base station of the system A receives the capability information of the UE, and saves the capability information in the context of the UE for later procedures.

The base station of the system A receives the capability information of the UE, and can also send the capability information of the UE to the core network of the system A through an interface signaling between the base station and the core network. For example, through a UE capability information indication message, the base station reports to the core network that the UE does not have the capability of being connected to the system A and the system B at the same time. The core network of the system A saves the capability information of the UE in the context of the UE for later procedures.

At step 302, the base station of the system A sends a paging data request message to the UE.

The base station of the system A receives the capability information of the UE and knows that the UE cannot receive a paging message of the system B while communicating with the system A. In order to prevent the system B from not being able to page the UE, the base station of the system A needs to know paging-related configuration information of the system B for the UE. After knowing such information, the base station of the system A can configure an interval for the UE. Within this interval, the UE suspends receiving and sending in the system A and hands over to the camped-on cell of the system B. If the system B initiates a paging request message, the UE can receive the paging message sent by the camped-on cell in the system B within this interval. In order to save the power of the UE, the UE uses a manner of discontinuous reception to receive the paging message. Within a paging cycle, the paging message is only sent at a certain paging occasion paging occasion (PO) within this paging cycle. At other time, the UE does not need to receive messages sent by the base station and can be in the sleep state so as to achieve the purpose of power saving. The optimal situation is that the interval configured by the base station of the system A exactly covers the occasion when the cell of the base station of the system B pages the UE. If this optimal configuration is desired to be achieved, the base station of the system A needs to know the paging-related discontinuous reception configuration of the UE in the system B. The base station of the system A can send to the UE the paging data request message, which indicates that the UE needs to report the paging-related configuration information of the system B to the base station of the system A, can also include configuration information to configure when the UE may receive the broadcast information of the camped-on cell of the UE in the system B, so as to get the paging-related information in the broadcast of the system B. According to the current algorithm for the paging cycle and the paging occasion PO, the paging-related configuration information can include one or more of the following information:

A paging identity of the UE, such as a temporary identity temporary mobile subscriber identity (TMSI) of the UE, 5G-S-TMSI, which is assigned by the core network and sent to the UE through a non-access stratum (NAS) message.

A paging discontinuous reception (DRX) parameter of the UE. The paging discontinuous reception parameter is configured by the core network and sent to the UE through a non-access stratum (NAS) message.

A default paging cycle, which is sent to the UE by the broadcast information of the cell. There is a default paging cycle for a cell.

A paging frame offset, which is sent to the UE by the broadcast information of the cell. There is a paging frame offset for a cell.

Upon receiving the message of step 302, the UE listens to the broadcast information of the system B at the corresponding time according to the configuration information.

At step 303, the UE listens to the broadcast information of the system B.

The UE suspends the data reception and transmission in the system A, hands over to the camped-on cell of the system B to listen to the system broadcast information, gets the broadcast information, and saves the broadcast information in the context of the UE. The broadcast information includes information related to the paging configuration. In the context, the UE also saves the paging-related information configured by the core network in the procedure of registration. The information related to the paging configuration is as described above.

At step 304, the UE sends a paging information report message to the base station of the system A.

The UE sends the paging-related configuration information of the system B to the base station of the system A through an RRC message. The paging-related configuration information can include one or more of the following information:

An identity of the system B, for example, indicating that the system B is 5G or LTE.

A paging identity of the UE, such as a temporary identity TMSI of the UE, 5G-S-TMSI, which is assigned by the core network and sent to the UE through a non-access stratum (NAS) message.

A paging discontinuous reception (DRX) parameter of the UE. The paging discontinuous reception parameter is configured by the core network and sent to the UE through a non-access stratum (NAS) message.

A default paging cycle, which is sent to the UE by the broadcast information of the cell. There is a default paging cycle for a cell.

A paging frame offset, which is sent to the UE by the broadcast information of the cell. There is a paging frame offset for a cell.

At step 305, the base station of the system A sends the paging-related configuration information of the system B to the core network of the system A.

Further, the base station may send the received paging-related configuration information of the system B to the core network. The core network saves the paging-related configuration information of the system B. The message at step 305 may be a dedicated message of the UE or a public message. If the message is a dedicated message of the UE, the message carries the identity at the interface of the UE.

At step 306, the base station of the system A configures a paging interval for the UE.

According to the got paging information of the system B, the base station of the system A can configure the measurement interval for the system B of the UE, and the measurement interval covers the paging occasion PO of the system B. In this measurement interval, the UE may not listen to the information of the system A, and turn to the system B to receive signals and messages of the cell of the system B. According to the received signal of the cell, for example, a quality of a reference signal, the UE can decide whether to perform the cell reselection in the system B and whether the camped on cell in the system B is to be changed, and can also receive a paging message sent by the cell of the system B in this measurement interval. The base station of the system B may also send paging indication information and/or a paging message to the UE in the measurement interval.

At step 307, the core network of the system A configures the paging discontinuous reception parameter of the UE.

If the core network finds that the paging configuration information of the system A conflicts with the paging configuration information of the system B, according to the current configuration information, the paging occasions PO of the two systems collide together. For example, the calculated paging cycles are the same, and paging occasions PO are the same too, which causes the UE to receive paging message only in one system. In order to avoid this situation, the core network of the system A can reconfigure a paging discontinuous reception (DRX) parameter for the UE through a NAS message. According to the new paging discontinuous reception (DRX) parameter of the UE, there is no conflict between the calculated paging occasion PO of the system A and the paging occasion PO of the system B. Or, a temporary identity is reconfigured for the UE, and there is no conflict between the calculated paging occasion PO of the system A by using the new temporary identity and the paging occasion PO of the system B.

At step 308, the base station of the system A sends an RRC connection release request message to the UE.

The base station of the system A decides to release the RRC connection, and sends the RRC connection release request message to the UE. The message includes the configuration information on measurement for the system A in the idle mode of the UE, and the configuration information on measurement for the system A includes information on the neighborhood cell measurement. The message also includes the configuration information on measurement for the system B in the idle mode of the UE. The base station A configures the measurement for the system B in the idle mode of the UE according to the configuration information related to the paging occasion of the system B previously received in step 306, so that the UE is able to hand over to the system B at an appropriate time and listen to the paging indication information and/or the paging message of the system B.

The UE is in the idle mode in the system A, calculates the paging occasion in the system A according to the configuration information of the paging DRX, and receives the paging message at the corresponding paging occasion. The configuration information on the paging DRX is sent to the UE by the core network of the system A or the base station of the system A through a broadcast message. According to the received measurement configuration information of the system B, the UE hands over to the system B in the corresponding slot, and receives the paging indication information and/or the paging message sent by the system B.

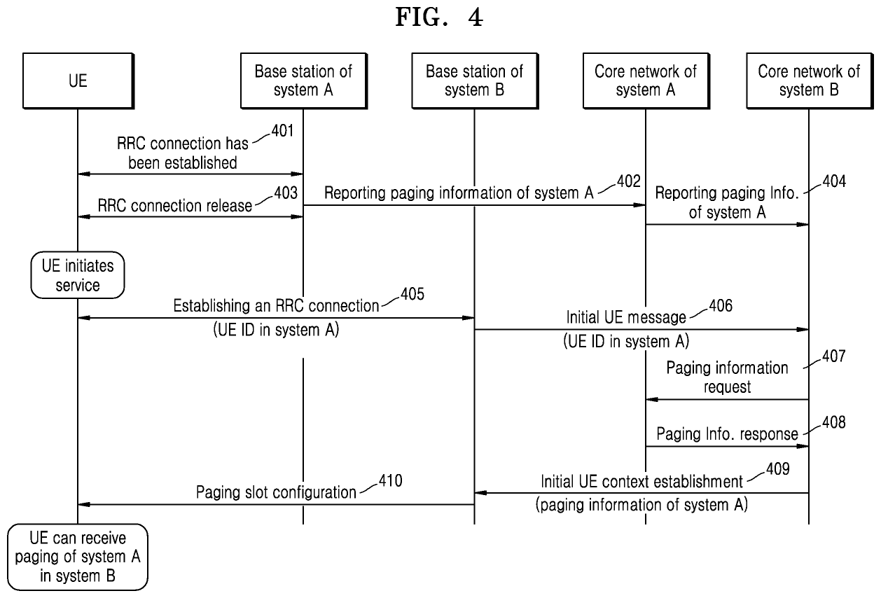

An embodiment of a method for paging optimization of the present disclosure is depicted in FIG. 4. A system A and a system B are two communication systems. A UE can be connected to the system A or the system B, and the UE cannot access to two systems A and B at the same time. FIG. 4 depicts a procedure in which the UE is in the idle mode in both the system A and the system B, and the UE initiates an RRC connection in the system B. Detailed descriptions of steps unrelated to the present disclosure are omitted here. The method includes following steps.

At step 401, the UE establishes an RRC connection with a base station of the system A.

The UE currently establishes a radio connection (RRC connection) with a cell of the base station of the system A. The cell is a serving cell of the UE. The base station and the cell are not distinguished below. The base station sends a message to the UE, which means that the cell of the base station sends the message to the UE. The current procedure can be used to establish the RRC connection. After the RRC connection is established, the UE sends the RRC message; or in the last message, i.e., an RRC setup complete message, in the procedure of establishing the RRC connection, the UE reports the capability information of the UE to the base station of the system A. The capability information of the UE indicates that the UE only has the capability of being connected to the system A or the system B, and does not have the capability of being connected to the system A and the system B at the same time. The capability information of the UE also indicates what kind of access system the system B is, such as 4G LTE, 5G LTE, 5G NR, etc. The UE currently has no RRC connection with the base station B of the system B, the UE camps on a certain cell in the system B, and the UE is in the idle mode. The system A can be a 3G system, a 4G system, a 5G system, or other wireless communication systems. The base station of the system A can be a 3G base station, a 4G base station, a 5G base station, or a base station of other radio access systems in the future. The system B can be a 3G system, a 4G system, a 5G system, or other wireless communication systems. The base station of the system B can be a 3G base station, a 4G base station, a 5G base station, or a base station of other radio access systems in the future.

At step 402, the base station of the system A sends paging information report of the system A to a core network of the system A.

The base station of the system A receives the capability information of the UE and knows that the UE cannot receive the paging message of the system B while communicating with the system A. In order to avoid the situation that the system A cannot page the UE after the UE enters the idle mode in the system A, the base station of the system A sends the paging information of the UE saved by the base station of the system A to the core network before the UE enters the idle mode or in the procedure that the UE enters the idle mode. For example, the paging information of the system A is carried in the UE context release request message.

The paging information of the system A can include one or more of the following information:

A default paging cycle, which is sent to the UE by the broadcast information of the cell. There is a default paging cycle for a cell.

A paging frame offset, which is sent to the UE by the broadcast information of the cell. There is a paging frame offset for a cell.

The core network of the system A already knows the temporary identity of the UE and the paging discontinuous reception (DRX) parameter of the UE, which have been all saved in the context of the UE. The core network of the system A saves the paging information of the system A received at step 402 in the context of the UE.

At step 403, the base station of the system A releases the RRC connection with the UE.

The UE also enters the idle mode in the system A.

At step 404, the core network of the system A sends information related to the paging configuration of the system A to a core network of the system B.

The core network of the system A sends the information related to the paging configuration of the system A to the core network of the system B. The information related to the paging configuration can include one or more of the following information:

A paging identity under the system A of the UE, such as a temporary identity TMSI of the UE, 5G-S-TMSI, which is assigned by the core network and sent to the UE through a non-access stratum (NAS) message.

A paging discontinuous reception (DRX) parameter of the UE in the system A. The paging discontinuous reception parameter is configured by the core network and sent to the UE through a non-access stratum (NAS) message.

A default paging cycle in the system A, which is sent to the UE by the broadcast information of the cell. There is a default paging cycle for a cell.

A paging frame offset in the system A, which is sent to the UE by the broadcast information of the cell. There is a paging frame offset for a cell.

At step 405, the UE establishes an RRC connection with the base station of the system B.

To initiate the establishment of a service, the RRC connection between the UE and the base station of the system B is firstly established. The current procedure can be used to establish the RRC connection. After establishing the RRC connection, the UE sends an RRC message; or in the last message, i.e., an RRC setup complete message, in the procedure of establishing the RRC connection, the UE reports the capability of the UE to the base station of the system B.

The UE can also send, to the base station of the system B, the UE temporary identity assigned by the core network of the system A and/or information for finding the core network node of the system A, and such information deliveries the UE temporary identity assigned by the base station of the system A to the system B through an RRC message. The base station of the system B gets the temporary identity, and sends the temporary identity to the core network of the system B through the interface between the base station and the core network. Or such information deliveries the UE temporary identity assigned by the base station of the system A to the base station of the system B through a NAS message, and the base station of the system B forwards the identity to the core network of the system B.

At step 406, the base station of the system B sends an initial UE message to the core network of the system B.

The message carries the temporary identity of the UE in the system A and/or the information for finding the core network node of the system A, for example, the routing area indication information of the UE in the system A.

The message can also carry the capability information of the UE. The capability information of UE indicates that the UE has only the capability of being connected to the system B or the system A, but has no the capability of being connected to the system A and the system B at the same time. The capability information of the UE also indicates what kind of access system the system A is, such as 4G LTE, 5G LTE, 5G NR, etc. Or the capability information including the temporary identity of the system A means that the UE does not have the capability to access to the system A and the system B at the same time.

At step 407, the core network of the system B requests the core network of the system A for the information related to the paging configuration of the UE.

If the core network of the system B does not have the information related to the paging configuration of the UE in the core network of the system A, the core network of the system B sends a paging information request to the core network of the system A.

At step 408, the core network of the system A sends the information related to the paging configuration of the UE to the core network of the system B.

At step 409, the core network of the system B sends a UE context establishment message to the base station of the system B.

The message includes the information related to the paging configuration of the system A. Upon receiving the configuration information, the base station of the system B saves the information in the context of the UE, and configures, according to the UE context information, the measurement interval in the system B of the UE, which covers the paging occasion PO of the system A. In this measurement interval, the UE may not listen to the information of the system B, and turn to the system A to receive signals and messages of the cell of the system A. According to the received signal of the cell, for example, a quality of a reference signal, the UE can decide whether to perform the cell reselection in the system A and whether the camped-on cell of the system A is to be changed, and can also receive a paging message sent by the cell of the system A in this measurement interval. The base station of the system A may also send paging indication information and/or the paging message to the UE in the measurement interval.

At step 410, the base station of the system B sends the configured paging interval to the UE.

According to the got paging information of the system A, the base station of the system B can configure the measurement interval for the system A of the UE, and the measurement interval covers the paging occasion PO of the system A. In this measurement interval, the UE may not listen to the information of the system B, and turn to the system A to receive signals and messages of the cell of the system A. According to the received signal of the cell, for example, a quality of a reference signal, the UE can decide whether to perform the cell reselection in the system A and whether the camped-on cell of the system A is to be changed, and can also receive a paging message sent by the cell of the system A in this measurement interval. The base station of the system A may also send paging indication information and/or paging messages to the UE in the measurement interval.

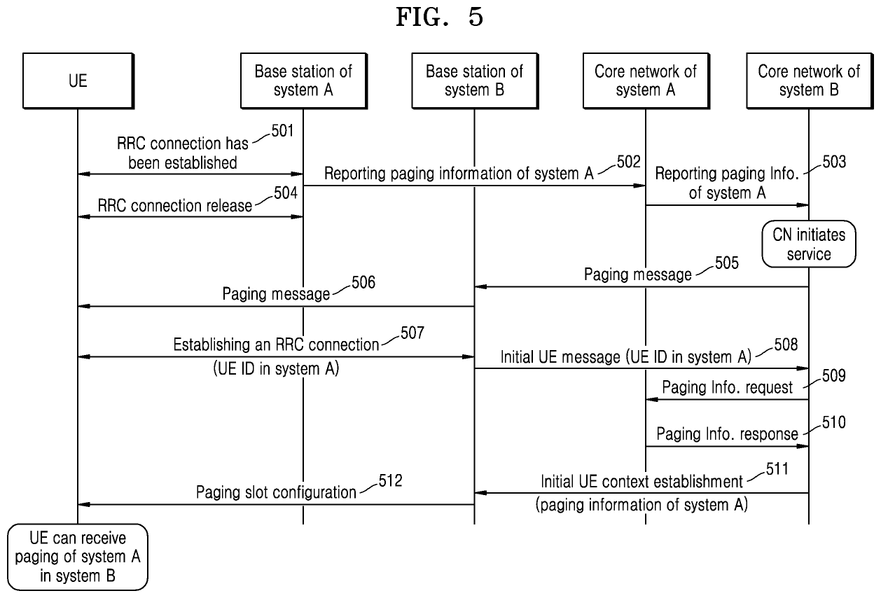

An embodiment of a method for paging optimization of the present disclosure is depicted in FIG. 5. A system A and a system B are two communication systems. A UE can be connected to the system A or the system B, and the UE cannot access to two systems A and B at the same time. FIG. 5 depicts a procedure in which the UE is in the idle mode in both the system A and the system B and the core network of the system B initiates a paging. Detailed descriptions of steps unrelated to the present disclosure are omitted here. The method includes following steps.

At step 501, the UE establishes an RRC connection with a base station of the system A.

The UE currently establishes a radio connection (RRC connection) with a cell of the base station of the system A. The cell is a serving cell of the UE. The base station and the cell are not distinguished below. The base station sends a message to the UE, which means that the cell of the base station sends the message to the UE. The current procedure can be used to establish the RRC connection. After the RRC connection is established, the UE sends the RRC message; or in the last message, i.e., an RRC setup complete message, in the procedure of establishing the RRC connection, the UE reports the capability information of the UE to the base station of the system A. The capability information of the UE indicates that the UE only has the capability of being connected to the system A or the system B, and does not have the capability of being connected to the system A and the system B at the same time. The capability information of the UE also indicates what kind of access system the system B is, such as 4G LTE, 5G LTE, 5G NR, etc. The UE currently has no RRC connection with a base station B of the system B, but has a camped-on cell, and the UE is in the idle mode. The system A can be a 3G system, a 4G system, a 5G system, or other wireless communication systems. The base station of the system A can be a 4G base station, a 5G base station, or a base station of other radio access systems in the future. The system B can be a 3G system, a 4G system, a 5G system, or other wireless communication systems. The base station of the system B can be a 3G base station, a 4G base station, a 5G base station, or a base station of other radio access systems in the future.

At step 502, the base station of the system A sends paging information report of the system A to a core network of the system A.

The base station of the system A receives the capability information of the UE and knows that the UE cannot receive a paging message of the system B while communicating with the system A. In order to avoid the situation that the system A cannot page the UE after the UE enters the idle mode in the system A, the base station of the system A sends the paging information of the UE saved by the base station of the system A to the core network before the UE enters the idle mode or in the procedure that the UE enters the idle mode. For example, the paging information of the system A is carried in the UE context release request message.

The paging information of the system A can include one or more of the following information:

A default paging cycle, which is sent to the UE by the broadcast information of the cell. There is a default paging cycle for a cell.

A paging frame offset, which is sent to the UE by the broadcast information of the cell. There is a paging frame offset for a cell.

The core network of the system A already knows a temporary identity of the UE and a paging discontinuous reception (DRX) parameter of the UE, which have been all saved in the context of the UE. The core network of the system A saves the paging information of the system A received at step 502 in the context of the UE.

At step 503, the core network of the system A sends information related to the paging configuration of the system A to a core network of the system B.

The core network of the system A sends the information related to the paging configuration of the system A to the core network of the system B. The information related to the paging configuration can include one or more of the following information:

A paging identity of the UE in the system A, such as a temporary identity TMSI of the UE, 5G-S-TMSI, which is assigned by the core network and sent to the UE through a non-access stratum (NAS) message.

A paging discontinuous reception (DRX) parameter of the UE in the system A. The paging discontinuous reception parameter is configured by the core network and sent to the UE through a non-access stratum (NAS) message.

A default paging cycle in the system A, which is sent to the UE by the broadcast information of the cell. There is a default paging cycle for a cell.

A paging frame offset in the system A, which is sent to the UE by the broadcast information of the cell. There is a paging frame offset for a cell.

At step 504, the base station of the system A releases the RRC connection with the UE.

The UE also enters the idle mode in the system A.

At step 505, the core network of the system B sends a paging message to the base station of the system B.

The system B wants to initiate sending service data. Since the UE is currently in the idle mode in the system B, the core network of the system B sends a paging message to the base station of the system B. The message carries information such as an identity of the paged UE, a DRX configuration parameter of the paging, a range of the paging, and a priority of the paging.

At step 506, the base station of the system B sends the paging message to the UE.

At step 507, the UE establishes an RRC connection with the base station of the system B.

In response to the paging message, the RRC connection between the UE and the base station of the system B is established firstly. The current procedure can be used to establish the RRC connection. After establishing the RRC connection, the UE sends an RRC message; or in the last message, i.e., an RRC setup complete message, in the procedure of establishing the RRC connection, the UE reports the capability of the UE to the base station of the system B.

The UE can also send a temporary identity of the UE assigned by the core network of the system A and/or information for finding the core network node of the system A to the base station of the system B, and such information deliveries the temporary identity of the UE assigned by the base station of the system A to the system B through an RRC message. The base station of the system B gets the temporary identity, and sends the temporary identity to the core network of the system B through the interface between the base station and the core network. Or such information deliveries the temporary identity of the UE assigned by the base station of the system A to the base station of the system B through a NAS message, and the base station of the system B forwards the identity to the core network of the system B.

The UE can also send the paging-related information in the system A to the base station, and the paging-related information is as described above. For example, the paging related information includes the temporary identity assigned by the system A to the UE, the paging discontinuous reception parameter of the UE, the default paging cycle in the system A, the paging frame offset in the system A, etc. The base station of the system B saves the paging-related information in the system A in the context of the UE for later procedures.

At step 508, the base station of the system B sends an initial UE message to the core network of the system B.

The message may carry the temporary identity of the UE in the system A and/or the information for finding the core network node of the system A. For example, the information for finding the core network node of the system A may include the routing area indication information of the UE in the system A.

The message can also carry the capability information of the UE. The capability information of UE indicates that the UE has only the capability of being connected to the system B or the system A, but has no the capability of being connected to the system A and the system B at the same time. The capability information of the UE also indicates what kind of access system the system A is, such as 4G LTE, 5G LTE, 5G NR, etc. Or that the capability information includes the temporary identity of the system A means that the UE does not have the capability to access to the system A and the system B at the same time.

The message may also include the paging-related information in the system A got by the base station of the system B. For example, the message includes the temporary identity assigned by the system A to the UE, the paging discontinuous reception parameter of the UE, the default paging cycle in the system A, the paging frame offset in the system A, etc.

At step 509, the core network of the system B requests the core network of the system A for the information related to the paging configuration of the UE.

Optionally, if the core network of the system B does not have the paging-related information in the system A of the UE, the core network of the system B sends a paging information request to the core network of the system A.

At step 510, the core network of the system A sends the paging-related information of the UE to the core network of the system B.

At step 511, the core network of the system B sends a UE context establishment message to the base station of the system B.

If the message includes the paging-related information in the system A, which is as described above, the base station of the system B saves the information in the context of the

UE.

At step 512, the base station of the system B sends the configured paging interval to the UE.

According to the got paging information of the system A, which can be got by the base station of the system B from the message of the UE as described in step 507, or from the core network as described in step 511, the base station of the system B can configure the measurement interval for the system A of the UE, which covers the paging occasion PO of the system A. In this measurement interval, the UE may not listen to the information of the system B, and turn to the system A to receive signals and messages of the cell of the system A. According to the received signal of the cell, for example, a quality of a reference signal, the UE can decide whether to perform the cell reselection in the system A and whether the camped-on cell in the system A is to be changed, and can also receive a paging message sent by the cell of the system A in this measurement interval. The base station of the system A may also send paging indication information and/or paging messages to the UE in the measurement interval.

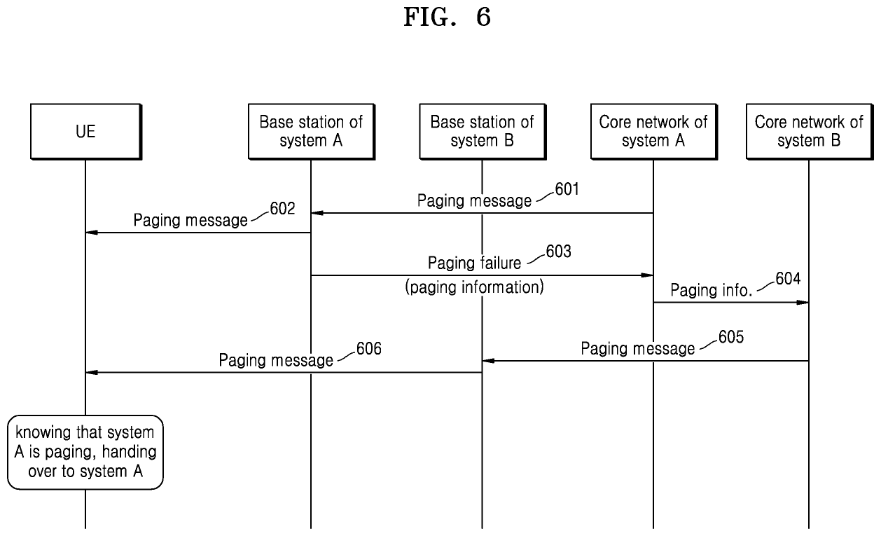

An embodiment of a method for paging optimization of the present disclosure is depicted in FIG. 6. A system A and a system B are two communication systems. A UE can be connected to the system A or the system B, and the UE cannot access to two systems A and B at the same time. FIG. 6 depicts a procedure in which the UE is in the idle mode in both the system A and the system B, and a core network of the system A fails to initiate a paging and sends the paging through the system B. Detailed descriptions of steps unrelated to the present disclosure are omitted here. The method includes following steps.

At step 601, the core network of the system A sends a paging message to a base station of the system A.

The core network of the system A wants to initiate establishment of a certain service. The core network of the system A knows that the UE is currently in the idle mode according to the context information of the UE. The core network of the system A sends the paging message to the base station of the system A. The message carries a temporary identity of the UE which is assigned to the UE by the core network of the system A. The message carries the paging discontinuous reception (DRX) information of the UE. The message also carries a paging range. For example, the paging range can be a list of routing areas, a list of cells, etc. The message may also carry a piece of indication information indicating that if the base station does not receive a paging response from the UE within a certain period of time or within a certain number of paging, the base station needs to notify the core network of a paging failure. The indication information may include one or more of the following information:

The indication information that is necessary to reply to the paging failure.

The maximum number of paging. A cell within the paging range of the base station sends the paging message to the UE. If a response from the UE is received, for example, an RRC establishment request message sent by the UE is received, the base station may stop sending the paging message; and if no response from the UE is received, the base station may repeatedly send the paging message to the UE. The maximum number of paging repetitions is set here. If the maximum number of paging repetitions is reached and no response from the UE has been received, the base station needs to send a paging failure message to the core network.

The maximum time of paging. Similar to the effect of the maximum number of paging, the base station can repeatedly send the paging message to the UE within this time. If the time of paging repetition reaches the maximum time and no response from the UE has been received, the base station needs to send the paging failure message to the core network.

At step 602, the base station of the system A sends the paging message to the UE.

According to the algorithm of paging, the base station of the system A calculates the paging cycle PF and the paging occasion PO of the UE, and sends the paging message at the corresponding position. The paging message includes the temporary identity of the UE.

At step 603, the base station of the system A sends a paging failure to the core network of the system A.

After repeated paging, the base station of the system A does not receive the paging response sent by the UE. For example, no response message from the UE has been received when the maximum number of repetitions is reached or the maximum time of repeated paging is reached. Thus, the base station of the system A sends a paging failure message to the core network of the system A. The paging failure message may indicate that the cause of the failure is that no response from the UE is received. A base station can send a paging failure message to the core network. For example, if multiple cells of the base station are within a data paging range, when all the cells do not receive a paging response under predetermined conditions, the base station sends a paging failure message to the core network. The message can also include paging-related information of the system A, and the paging-related information is as shown above. For example, the message includes the temporary identity assigned by the system A to the UE, the paging discontinuous reception parameter of the UE, the default paging cycle in the system A, the paging frame offset in the system A, etc.

At step 604, the core network of the system A sends the paging information to a core network of the system B.

If all the base stations within the paging range replying to the paging failure message, the core network of the system A knows the capability information of the UE according to the saved context information of the UE. The capability information of the UE indicates that the UE only has the capability of being connected to the system A or the system B, and does not have the capability of being connected to the system A and the system B at the same time. The capability information of the UE also indicates what kind of access system the system B is, such as 4G LTE, 5G LTE, 5G NR, etc. The core network of the system A judges that the UE cannot receive the paging message currently in the system A, and needs to send the paging message to the UE through a base station of the system B. The core network of the system A sends the paging information to a control node of the system B, or the core network of the system A sends the paging information to a certain node of the core network of the system B. The node of the system B sends the paging information to a core network control node of the UE in the system B. The paging-related information of step 604 may carry one or more of the following information:

An identity of the UE, such as a unique identity of the UE in the system B, and/or a unique identity of the UE in the system A.

Paging-related information in the system A, such as the temporary identity assigned to UE by the system A, the paging discontinuous reception (DRX) parameter of the UE, the default paging cycle in the system A, the paging frame offset in the system A, etc.

An identity or a type of the service initiated by the paging.

A core network node of the system B finds the core network control node in the system B of the UE, for example, the core network node can find the core network control node in the system B of the UE according to the unique identity of the UE in the system B. Then, the core network node that receives the message of step 604 forwards the paging information to the core network control node.

At step 605, the core network of the system B sends the paging message to the base station of the system B.

The message carries the temporary identity assigned to the UE by the core network of the system B, such as TMSI. The temporary identity of the UE is assigned to the UE by the core network of the system B and is saved in the context of the UE. The paging discontinuous reception (DRX) parameter of the UE carried by the message is assigned to the UE by the core network of the system B. The message also carries indication information of the paging initiation system. The indication information may indicate the name or the abbreviation of the system, such as 4G, 5G, and so on. In the present embodiment, the indication information indicates that the paging is initiated by the system A. Since the system A desire to establish a service and initiates the paging message, the message may also carry the identity or the type of the service for which the paging is initiated.

At step 606, the base station of the system B sends the paging message of the system A to the UE.

The message carries the temporary identity of the UE which is assigned to the UE by the core network of the system B and is saved in the context of the UE. The message also carries the indication information of the paging initiation system and/or the identity or the type of the service for which the paging is initiated. The indication information is as described in step 605.

The UE initiates an RRC establishment request to establish an RRC connection with the base station of the system A.

According to the indication information of the initiation system carried in the received paging message, if the indication information of the initiation system included in the paging message received by the UE from the base station of the system B indicates that the system initiating the paging is the system A, the UE hands over to the system A and initiates the procedure of RRC connection establishment request. The cause of RRC establishment can be set to initiating a connection by a network or set to a paging response. The base station receives the RRC establishment request and sends an RRC establishment message to the UE. The subsequent procedure is similar to the current RRC establishment completion and is omitted here.

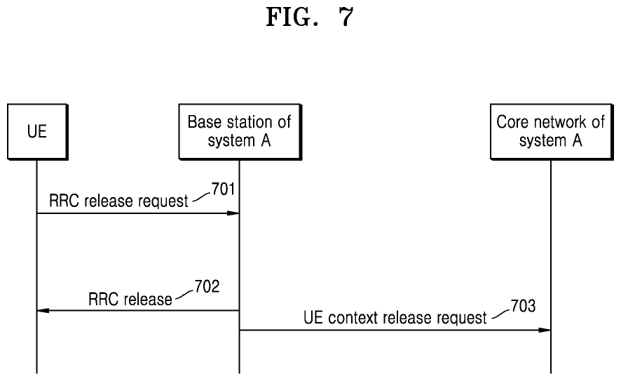

An embodiment of a method for paging optimization of the present disclosure is depicted in FIG. 7. A system A and a system B are two communication systems. A UE can be connected to the system A or the system B, and the UE cannot access to two systems A and B at the same time. FIG. 7 depicts a procedure in which the UE releases an RRC connection in the system A and establishes an RRC connection with the system B. Detailed descriptions of steps unrelated to the present disclosure are omitted here. The method includes following steps.

At step 701, the UE sends a release request to a base station of the system A.

The UE has currently established the RRC connection with the system A. In the system A, the UE is in the connection mode. After the RRC connection is established, the system A configures the measurement of the UE according to the capability of the UE. If the UE is a dual-mode UE and supports the data transmission and reception in two systems A and B, but cannot listen to the signals of systems A and B at the same time, the base station of the system A configures the data discontinuous reception for the UE, that is, configures a measurement interval within which the UE can hand over to the system B to listen to messages and/or signals of the system B, such as the broadcast information or paging information of the system B.

If the UE receives an RRC paging message sent by the base station of the system B, the RRC paging message includes a temporary identity of the UE (for example, a temporary identity TMSI of the UE), a type of service for which the paging message is initiated (for example, the service for which the paging is initiated is voice service or IoT service), and so on. The UE decides to receive the service of the system B, and the UE is to release the connection with the system A.

The UE sends an RRC release request message to the base station of the system A. The RRC message can also indicate whether the UE continues to maintain the signaling connection with the system A. The message can also indicate a piece of time information. The signaling connection is maintained within this time, and the UE can enter the idle mode when this time is exceeded. The RRC message also includes the cause of the release. The cause of the release can be set as the cause of dual-mode single-standby and/or the type of service received by the system B.

If the RRC message includes the indication of whether the UE continues to maintain the signaling connection with the system A, according to the indication information, the core network decides whether to release the signaling connection with the UE and suspend the data transmission to the UE, for example, letting the UE enter the suspended state.

If the RRC message includes the type of service to be accessed to the system B, the base station of the system A can decide whether to let the UE be in the idle mode or the RRC-Inactive mode in the cell of the system A according to the type of service. Further, according to the type of service, the base station of the system A can configure a time, and if the UE returns to the system A within this time, the signaling connection and the data connection can be restored. If this time is exceeded, the base station releases the RRC connection of the UE. If the base station decides to let the UE be in the idle mode, the base station of the system A sends an RRC connection release message to the UE. If deciding to let the UE enter the RRC-Inactive mode, the base station of the system A sends an RRC suspend request message to the UE. After that, the UE hands over to the system B and sends an RRC connection request message to the base station of the system B.

At step 702, the base station of the system A sends an RRC release message to the UE.

If the base station of the system A lets the UE enter the RRC-inactive mode, the RRC release message includes a suspend indication and may also include a piece of time information, indicating that if the UE returns to the cell of the system A before this time, the context of the UE can be resumed. If the UE returns to the cell of the system A after this time, it is necessary to initiate the RRC establishment procedure.

At step 703, the base station of the system A sends a UE context release request message to the core network.

If the base station of the system A decides to let the UE enter the RRC idle mode, the base station sends the UE context release request message.

If the base station of the system A lets the UE enter the RRC-inactive mode, and the UE does not initiate the RRC resume procedure within the indicated time, the base station sends the UE context release request message to the core network.

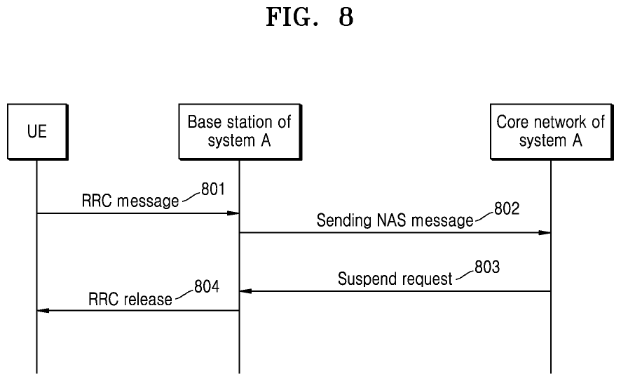

An embodiment of a method for paging optimization of the present disclosure is depicted in FIG. 8. A system A and a system B are two communication systems. A UE can be connected to the system A or the system B, and the UE cannot access to two systems A and B at the same time. FIG. 8 depicts a procedure in which the UE releases the RRC connection in the system A and establishes the RRC connection with the system B. Detailed descriptions of steps unrelated to the present disclosure are omitted here. The method includes following steps.

At step 801, the UE sends an uplink RRC message to a base station of the system A.

The UE has currently established an RRC connection with the system A. In the system A, the UE is in the connected mode. After the UE establishes the RRC connection with the system A, the system A configures the measurement of the UE according to the capability of the UE. If the UE is a dual-mode UE and supports the data transmission and reception in two systems A and B, but cannot listen to the signals of systems A and B at the same time, the base station of the system A configures the data discontinuous reception for the UE, that is, the base station of the system A configures a measurement interval within which the UE can hand over to the system B to listen to messages and/or signals of the system B, such as the broadcast information or paging information of the system B.

If the UE receives an RRC paging message sent by the base station of the system B, the RRC paging message including a temporary identity of the UE (such as the temporary identity of the UE TMSI), the type of service for which the paging message is initiated (for example, the service for which the paging is initiated is voice service or IoT service), and so on. The UE decides to receive the service of the system B, the UE is to release the connection with the system A.

The UE sends the uplink RRC message to the base station of the system A. The message carries a NAS message, such as a service request. The service request message indicates that the UE needs to release all service connections with the system A. The message can also indicate whether the UE continues to maintain the signaling connection with the system A. The message can also indicate a piece of time information. The signaling connection is maintained within this time, and the UE can enter the idle mode when this time is exceeded. The message also includes a cause of the release. The cause of the release can be set as the capability of the UE being dual-mode single-standby, or the cause of the release indicating that the UE is currently going to access to the system B to receive services, and/or the name of the system B, and/or the type of service received in the system B. Or the cause of the release is included in the RRC message.

At step 802, the base station of the system A sends the NAS message to the core network.

The base station of the system A sends the received NAS message and/or the cause of the release to the core network of the system A. The core network receives the cause of the release, knows that the UE is currently going to access to the system B to receive services, and is aware of the type of services of the system B. The core network judges whether to release connections of all services, including signaling connections and/or user data plane connections. If it is judged that the UE can end the service of the system B very soon, the core network can configure a time. If the UE returns to the system A within this time, the signaling connection and the data connection can be resumed. If this time is exceeded, the core network initiates the UE context release procedure.

If the NAS message received by the core network includes the indication whether the UE continues to maintain the signaling connection with the system A, according to the indication information, the core network decides whether to release the signaling connection with the UE and suspend the data transmission to the UE, for example, letting the UE enter the suspended state.

At step 803, the core network sends a UE context suspend message to the base station of the system A.

If the core network decides to suspend the data transmission of the system A, the core network sends a message to the base station. The message may carry a non-access stratum message, and also carry an indication of UE context suspend, and/or carry a piece of time information. According to the indication of UE context suspend, the base station can decide to let the UE enter the RRC-inactive mode. According to the time information, the base station may decide to send the RRC release request message to the UE, release the context information of the UE, and/or release the connection with the core network, if the time is exceeded.

The non-access stratum message indicates that the service connection is released or suspended. The non-access stratum message can also carry a piece of time information. It is indicated to the UE that if the UE returns to the system A within this time, the UE is in the suspended state in the system A, and the UE can initiate a resume request to resume the signaling connection and data connection with the system A. If the UE returns to the system A beyond this time, the UE is in the RRC idle state in the system A, and the UE needs to initiate an RRC establishment request message.

At step 804, the base station of the system A sends an RRC release message to the UE.

If the base station lets the UE enter the RRC-inactive mode, the RRC release message includes a suspend indication. The RRC release message can also include a piece of time information. If returning to the system A within this time, the UE is in the suspended state in the system A, and the UE can initiate the resume request to resume the signaling connection and data connection with the system A. If returning to the system A beyond this time, the UE is in the RRC idle state in the system A, and the UE needs to initiate the RRC establishment request message.

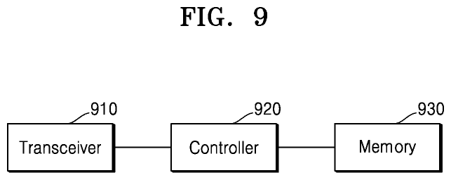

FIG. 9 illustrates a block diagram of a network device according to the present disclosure.

The network device can be used to implement the UE, the base station of the system A, the core network node of the system A, the base station of the system B, and the core network node of the system B of the present disclosure. Referring to FIG. 9, the network device according to the present disclosure may comprise a transceiver 910, a controller 920, and a memory 930. The transceiver 910, the controller 920, and the memory 930 are configured to perform the operations of various embodiments of the present disclosure. Although the transceiver 910, the controller 920, and the memory 930 are shown as separate entities, they may be implemented as a single entity, such as a single chip. The transceiver 910, the controller 920, and the memory 930 may be electrically connected or coupled to each other. The transceiver 910 may send signals to and receive signals from other network devices, such as UEs, base stations, or core network nodes. The controller 920 may include one or more processing units, and may control the network device to perform operations and/or functions according to one of the above-mentioned embodiments. The memory 930 may store instructions for implementing the operations and/or functions of one of the above-mentioned embodiments.

So far, an improved method and device for initiating a service request by a network and paging a UE by the network of the present disclosure is completed, which can avoid paging failures, increase the success rate of initiating service requests by the network, avoid UE power consumption, and reduce the delay of paging messages.

The programs running on the device according to the present disclosure may be programs that enable the computer to implement functions of the embodiments of the present disclosure by controlling a central processing unit (CPU). The programs or information processed by the programs may be temporarily stored in a volatile memory, such as a random access memory (RAM), a hard disk drive (HDD), a non-volatile memory (e.g., flash memory), or other memory system.

The programs for realizing the functions of the embodiments of the present disclosure may be recorded on a computer-readable recording medium. Corresponding functions can be realized by making the computer system read the programs recorded on the recording medium and execute these programs. The so-called “computer system” herein may be a computer system embedded in the device, and may include an operating system or hardware, such as a peripheral device. The “computer-readable recording medium” may be a semi-conductor recording medium, an optical recording medium, a magnetic recording medium, a recording medium for a short-time dynamic storage program, or any other computer readable recording medium.

Various features or functional blocks of the device used in the above embodiments may be implemented or executed by circuitry (e.g., monolithic or multi-chip integrated circuits). The circuitry designed to perform the functions described in this specification may include general purpose processors, digital signal processors (DSPs), application specific integrated circuits (ASICs), field programmable gate arrays (FPGAs), or other programmable logic devices, discrete gate or transistor logic, discrete hardware components, or any combination of the above devices. The general purpose processor may be a microprocessor or any existing processor, controller, microcontroller, or state machine. The circuit may be a digital circuit or an analog circuit. One or more embodiments of the present disclosure may also be implemented using these new integrated circuit techniques in the event of a new integrated circuit technology that replaces existing integrated circuits due to advances in semiconductor technology.

As described above, the embodiments of the present disclosure have been described in detail with reference to the accompanying drawings. However, the specific structure is not limited to the above-described embodiments, and the present disclosure also includes any design modifications that do not depart from the spirit of the present disclosure. In addition, various modifications may be made to the present disclosure within the scope of the claims, and the embodiments obtained by appropriate combinations of the technical means disclosed in the different embodiments are also included within the technical scope of the present disclosure. In addition, the components having the same effects described in the above embodiments may be substituted for each other.

The foregoing descriptions are only preferred embodiments of the present disclosure and a description of the technical principles of the present disclosure. It should be understood by the skilled in the art that the scope of the present disclosure recited in this application is not limited to the particular combinations of the above technical features and should also cover other technical solutions formed by any combinations of the technical features described above or their equivalent features without departing from the inventive concept, e.g., the technical solutions formed by the above mentioned features being interchangeable with, but not limited to, technical features having similar functions as disclosed in this application.

What is claimed is:

1. A method for paging performed by a base station of a first communication system, comprising:
receiving, from a user equipment (UE), a first message including information for paging configuration of a second communication system; and
sending, to the UE, a second message for configuring a measurement for the second communication system of the UE according to the information for the paging configuration of the second communication system.

2. The method according to claim 1, further comprising:
sending, to the UE, a third message for requesting the paging configuration of the second communication system.

3. The method according to claim 1, further comprising:
sending, to a core network node of the first communication system, a fourth message for reporting information for paging the second communication system.

4. The method according to claim 3, wherein the information for the paging configuration of the second communication system includes at least one of:
a system identity in the second communication system,
a paging identity of the UE in the second communication system,
a paging discontinuous reception parameter of the UE in the second communication system,
a default paging cycle in the second communication system, or
a paging frame offset in the second communication system.

5. A method for paging performed by a first core network node of a first communication system, comprising:
receiving, from a base station of the first communication system, a first message for reporting paging information for the first communication system; and
sending, to a second core network node of a second communication system, a second message including information for paging configuration of the first communication system.

6. The method according to claim 5, wherein the paging information for the first communication system includes at least one of:
a default paging cycle in the first communication system, or
a paging frame offset in the first communication system.

7. The method according to claim 5, wherein the information for the paging configuration of the first communication system includes at least one of:
a paging identity of a user equipment (UE) in the first communication system,
a paging discontinuous reception parameter of the UE in the first communication system,
a default paging cycle in the first communication system, or
a paging frame offset in the first communication system.

8. A method for paging performed by a base station of a second communication system, comprising:
receiving, from a core network node of the second communication system, a first message for establishing user equipment (UE) context; and
sending, to the UE, a second message for configuring a measurement interval for a first communication system of the UE,
wherein the first message for establishing the UE context includes first information for paging configuration of the first communication system.

9. The method according to claim 8, wherein the first information for the paging configuration of the first communication system includes at least one of:
a paging identity of the UE in the first communication system,
a paging discontinuous reception parameter of the UE in the first communication system,
a default paging cycle in the first communication system, or
a paging frame offset in the first communication system.

10. The method according to claim 8, further comprising:
receiving, from the UE, a third message requesting to establish a radio resource control (RRC) connection,
wherein, the third message requesting to establish the RRC connection includes an identity of the UE in at least one of the first communication system or second information for finding a core network node of the first communication system.

11. The method according to claim 8, further comprising:
sending, to the core network node of the second communication system, a fourth message including initial information for the UE,
wherein, the fourth message for the initial information of the UE includes an identity of the UE in at least one of the first communication system or third information for finding a core network node of the first communication system.

12. A method for paging performed by a first core network node of a first communication system, comprising:
receiving, from a base station of the first communication system, a first message indicating a paging failure, the first message including information for paging the first communication system; and
sending, to a second core network node of a second communication system, the information for paging the first communication system.

13. The method according to claim 12, wherein the information for paging the first communication system includes at least one of:
a temporary identity assigned to a UE by the first communication system,
a paging discontinuous reception parameter of the UE in the first communication system,
a default paging cycle in the first communication system, or
a paging frame offset in the first communication system.
